(19) United States
(12) Patent Application Publication
(10) Pub. No.: US 2014/0262338 A1
(43) Pub. Date: Sep. 18, 2014

(54) BLENDER SYSTEM WITH MULTIPLE STAGE PUMPS

(71) Applicant: SCHLUMBERGER TECHNOLOGY CORPORATION, (US)

(72) Inventors: Christopher Shen, Houston, TX (US); Edward Leugemors, Needville, TX (US); Rod Shampine, Houston, TX (US); William Troy Huey, Fulshear, TX (US); Rajesh Luharuka, Katy, TX (US)

(73) Assignee: SCHLUMBERGER TECHNOLOGY CORPORATION, Sugar Land, TX (US)

(21) Appl. No.: 13/837,846

(22) Filed: Mar. 15, 2013

(51) Int. Cl. B01F 5/16

(52) U.S. Cl. CPC B01F 5/162
USPC 166/381; 366/182.2

(57) ABSTRACT

A blending system for oilfield operations is disclosed having a first stage pump with a mixer having a housing and an impeller and configured to receive a liquid component at an initial pressure and a dry component and mix the liquid and dry components to form a slurry, add energy to the slurry to increase its pressure above the initial pressure, and discharge the slurry through an outlet at a first pressure, and a second stage pump with an inlet and an outlet, the inlet in fluid communication with the first stage pump. The second stage pump is configured to receive the slurry from the first stage pump and pressurize the slurry to a second pressure at the outlet of the second stage pump. The second stage pump is positioned relative to the first stage pump to minimize a pressure loss between the first stage pump and the second stage pump.

### TECHNICAL FIELD

The present disclosure generally relates to systems, apparatuses, or methods of mixing and metering proppant into fracturing fluid to be injected into a wellbore.

### BACKGROUND

In hydraulic fracturing, fracturing fluid is injected into a wellbore, penetrating a subterranean formation and forcing the fracturing fluid at pressure to crack and fracture the strata or rock. Proppant is placed in the fracturing fluid and thereby placed within the fracture to form a proppant pack to prevent the fracture from closing when pressure is released, providing improved flow of recoverable fluids, i.e., oil, gas, or water. The success of a hydraulic fracturing treatment is related to the fracture conductivity which is the ability of fluids to flow from the formation through the proppant pack. In other words, the proppant pack or matrix may have a high permeability relative to the formation for fluid to flow with low resistance to the wellbore. Permeability of the proppant matrix may be increased through distribution of proppant and non-proppant materials within the fracture to increase porosity within the fracture.

Prior to injection of the fracturing fluid, the proppant and other components of the fracturing fluid may be blended. Hydraulic fracturing operations may blend and pump more than 3 million pounds or 1.3 million kilograms of proppant or dry components per day at a wellsite. Proppant is often stored in silos or other types of units on site, which deliver the proppant into a hopper associated with a blending unit. The proppant is then metered from the hopper into a mixer.

Dry components, such as proppants, and liquid components, such as gels, may be blended into the fracturing fluid, often referred to as a slurry, in a blender. Blenders, such as the blender described in U.S. Pat. No. 4,453,829, may have slinger elements of a toroidal configuration with a concave upper surface. Several upstanding blade members are mounted on the concave surface of this slinger and an impeller member is attached to the underside of the slinger. The slinger and impeller are enclosed within a housing and fastened to the end of a drive shaft rotated by a motor mounted above the housing. A hopper is mounted above an inlet eye in the top of the housing, for introducing sand or other solid particles or dry components into the housing. At the bottom of the housing is a suction eye inlet, for drawing fluid or liquid components into the housing and the resulting fluid-solid mixture is discharged through an outlet port in the housing.

In the operation of the blender described above, sand flows out of the hopper and drops onto the rotating slinger through the inlet eye in the housing. With the impeller and slinger rotating at the same speed, the vortex action of the impeller creates a suction force that draws liquid into the casing through the suction eye inlet. As the liquid is pulled into the casing it is pressurized by the impeller and mixed thoroughly with the sand being flung outwardly, in a centrifugal action, from the slinger. The sand-liquid mixture is then continuously discharged, under pressure, through the outlet port, from which it is carried into the pump unit and injected into a well. Some blenders, such as the one described above, may cause air within the dry component to become entrained in the slurry.

Other blenders, such as the one described in U.S. Pat. No. 4,614,435, are designed to mix dry components with fluid components without entraining air into the resulting slurry. The dry components are contained in a hopper mounted above the inlet eye of a housing member. The outlet end of the hopper sets above the inlet eye to provide an exterior air exhaust space at this point on the blender. The housing encloses a slinger and impeller member that is fastened to the underside surface of the slinger.

The impeller and slinger are both fastened to the bottom end of a drive shaft that extends up through the inlet eye of the housing to a motor that rotates the shaft. The slinger has a toroidal configuration and a topside concave surface that faces toward the top of the housing. The underside surface of the slinger has a recess in it and the recess defines an interior air exhaust space between the slinger and impeller. The slinger also has one or more interior air exhaust channels that extend from the air exhaust space between the slinger and impeller up to the topside surface of the slinger. To obtain a desired pressure output of 60 to 80 PSI (Pounds per Square Inch), the slinger and impeller may be rotated at a speed between 1,200 and 1,400 RPM (Revolutions Per Minute). The high rotational speed in conjunction with the abrasive nature of the proppant being agitated by the impeller and slinger causes erosion on the impeller and slinger components and often causes the blender to wear out, necessitating frequent maintenance and rebuilding.

In addition to the above mentioned blenders that provide a pressurized output above hydrostatic pressure, tub blenders are also used. Tub blenders separate the mixing and pumping operations. A tub mixer delivers proppant and fluid into a large tub which contains an agitation mechanism, such as a rotational paddle or horizontal ribbon mixer. Mixing of the dry component and liquid component occurs in this tub at hydrostatic pressure due to gravity, and a centrifugal pump then takes fluid from the bottom of the tub and discharges the fluid under pressure at about 80 PSI to high pressure fracturing pumps or a manifold trailer connected to the pumps.

Further, some blenders use centrifugal pumps to pump clean liquid components into a closed tub with a rotating slinger at the top of the tub. The centrifugal pump pressurizes the entire tub, and the slinger introduces and mixes the dry component into the liquid component to create the slurry. The slurry then exits the tub at a tangential discharge point in the housing. The slinger within the tub does not impart energy to the slurry above the energy received from the centrifugal pump as a result of the centrifugal pump pressurizing the tub.

In any type of blender used for creating the slurry, there are components that undergo significant amounts of erosion and wear due to the highly abrasive nature of the proppant within the slurry. Additionally, some blenders may also present issues with respect to maintaining sufficient discharge pressure to the high pressure pumps or manifold. The high pressure pumps may be located on the wellsite at a considerable distance from the blender unit, at times being over 150 ft or over 45 m away from the blender. The pressure drop through the hose extending between the blender unit and the high pressure pump or manifold may cause insufficient suction pressure conditions at the high pressure pumps thereby causing undue wear on the high pressure pumps due to starvation or cavitation.

Thus, what is needed is a blending system that provides a pressurized output in a range of normally between 60-80 PSI without having the maintenance issues described above. It is to such an improved blending system that the present disclosure is directed.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one embodiment, a blending system is described. The blending system has a first stage pump and a second stage pump. The first stage pump has a mixer having a housing and an impeller. The mixer receives a liquid component at an initial pressure and a dry component to mix the liquid component and the dry component to form a slurry, adds energy to the slurry to increase a pressure of the slurry above the initial pressure at an outlet, and discharges the slurry through the outlet at a first pressure above hydrostatic pressure due to gravity and above the initial pressure. The second stage pump has an inlet and an outlet. The inlet of the second stage pump is in fluid communication with the outlet of the first stage pump. The second stage pump receives the slurry from the first stage pump and pressurizes the slurry to a second pressure above the first pressure at the outlet. The second stage pump is positioned relative to the first stage pump to minimize the pressure loss between the first stage pump and the inlet of the second stage pump.

In another embodiment, a blending system is described as having a blender, a second stage pump, and a support structure. The blender is provided with a hopper for containing a dry component of an oilfield fracturing slurry and a first stage pump. The hopper has an inlet and an outlet. The first stage pump has a first inlet and a second inlet. The first inlet of the first stage pump is in fluid communication with the outlet of the hopper to receive the dry component of the oilfield fracturing slurry. The second inlet of the first stage pump receives a liquid component of the oilfield fracturing slurry. The first stage pump has a mixer with a housing and an impeller. The mixer receives the liquid component at an initial pressure and the dry component, and mixes the liquid component and the dry component to form the oilfield fracturing slurry, adds energy to the oilfield fracturing slurry, and discharges the oilfield fracturing slurry at a first pressure above hydrostatic pressure and above the initial pressure. The second stage pump is in fluid communication with the first stage pump and receives the oilfield fracturing slurry from the first stage pump and pressurizes the oilfield fracturing slurry to a second pressure for discharge. The second stage pump is positioned relative to the first stage pump to minimize a pressure loss between the first stage pump and the inlet of the second stage pump. The support structure supports the blender and the second stage pump. In one embodiment, the support structure is a trailer designed to be pulled by a tractor to transport the blender and the second stage pump.

In yet another embodiment, a method is described. The method is performed by installing a blending system in an oilfield fracturing system located at a well site operation. The blending system is provided with a first stage pump to mix a liquid component and a dry component to form a slurry and discharge the slurry through an outlet at a first pressure above hydrostatic pressure due to gravity. The blending system is also provided with a second stage pump with an inlet in fluid communication with the first stage pump. The second stage pump receives the slurry from the first stage pump and pressurizes the slurry to a second pressure above the first pressure at an outlet. The second stage pump is positioned relative to the first stage pump to minimize the pressure loss between the first stage pump and the inlet of the second stage pump. The method is further performed by transferring a dry component into the first stage pump, transferring the liquid component into the first stage pump, and operating the first stage pump to mix the dry component and the liquid component into a slurry, pressurize and discharge the slurry from the first stage pump at the first pressure, and pressurize and discharge the slurry from the second stage pump at the second pressure.

### BRIEF DESCRIPTION OF THE DRAWINGS

FIG. 1 shows a diagrammatic representation of a pair of blending systems, with first and second stage pumps, connected to a manifold in accordance with the present disclosure.

FIG. 2 shows a partial cross sectional view of a blender with a first stage pump in accordance with a blending system of the present disclosure.

FIG. 3 shows a perspective view of one embodiment of a second stage pump of the blending system in accordance with the present disclosure.

FIG. 4 shows a cross sectional view of the second stage pump of FIG. 4 taken along line 4-4.

FIG. 5 shows a block diagram of a method for using the blending system in accordance with the present disclosure.

FIG. 6 shows a perspective view of a blending system constructed in accordance with the present disclosure integrated onto a trailer.

### DETAILED DESCRIPTION

At the outset, it should be noted that in the development of any such actual embodiment, numerous implementation specific decisions will be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In the summary and this detailed description, each numerical value should be read once as modified by the term “about” (unless already expressly so modified), and then read again as not so modified unless otherwise indicated in context. Also, in the summary and this detailed description, it should be understood that a range listed or described as being useful, suitable, or the like, is intended to include any within the range, including the end points, and is to be considered as having been stated. For example, “a range from 1 to 10” is to be read as indicating each possible number along the continuum between about 1 and about 10. Thus, even if specific data points within the range, or even no data points within the range, are explicitly identified or refer to a few specific, it is to be understood that the inventors appreciate and understand that any data points within the range are to be considered to have been specified, and that inventors possessed knowledge of the entire range and all points within the range.

Referring now to FIG. 1, shown therein is a pair of blending systems 10-1 and 10-2 for oilfield operations. In order to simplify the description, a single blending system 10 will be discussed hereinafter. The blending system 10 is provided with a first stage pump 12 and a second stage pump 14 in fluid communication with the first stage pump 12 via a fluid connection 16. Both the first stage pump 12 and the second stage pump 14 are described in more detail below. The second stage pump 14 may enable a reduction in speed of the first stage pump 12 than may otherwise be used and thereby reduce wear and tear on the components of the first stage pump 12. In one embodiment, the first stage pump 12 can be operated between 800 and 1000 RPM, rather than the 1200-1400 RPM that the prior art blender was operated. Reducing the speed of revolution of the first stage pump 12 results in a significant increase in reliability for the first stage pump 12 as compared to the prior art blender. The first stage pump 12 is provided with a mixer 18 configured to mix a liquid component 20 and a dry component 22 to form a slurry and discharge the slurry through an outlet 23 at a first pressure that is above hydrostatic pressure due to gravity. The liquid component 20 may be a gel formed by a mixture of water and guar. The dry component can be a proppant, such as sand. The second stage pump 14 has an inlet 24-1 and an outlet 24-2 and is configured to receive the slurry from the first stage pump 12 at the first pressure through the inlet 24-1 and pressurize the slurry to a second pressure above the first pressure at the outlet 24-2. The second stage pump 14 is positioned relative to the first stage pump 12 to minimize the pressure loss between the first stage pump 12 and the second stage pump 14. For example, the second stage pump 14 may be positioned relative to the first stage pump 12 to prevent a loss of pressure greater than 20% of the first pressure. The second stage pump 14 may be in fluid communication with a manifold 25 which transfers the slurry to a high pressure pump of the oilfield operation and downhole to fracture a formation surrounding a wellbore. For example, the first pressure can be in a range of 10-50 PSI, the second pressure can be in a range of 50-100 PSI, and the high-pressure pump may pressurize the slurry up to about 15,000 PSI.

A predetermined slurry discharge pressure may be maintained by adjusting the speed of the first stage pump 12 and/or the second stage pump 14 to coincide with specific elements of the oilfield operation. The first stage pump 12 may be a programmable optimum density (POD) blender and may include a centrifugal pump, a vortex pump, an impeller pump, or any other suitable pump. The second stage pump 14 may also be a centrifugal pump, a vortex pump, an impeller pump, or any other suitable pump. The second stage pump 14 may be made of a wear resistant material, such as high-nickel or high-chrome white cast iron, for example. In one embodiment, the second stage pump 14 may be a recessed-impeller pump. In one embodiment, the first pressure is in a range from 10 PSI to 50 PSI and is more preferably in a range from 20 PSI to 30 PSI.

The first stage pump 12 may be in fluid communication with the second stage pump 14 via the fluid connection 16. In one embodiment, the fluid connection 16 may be a hose, a pipe, a combination thereof, or any other connection mechanism suitable to receive and transfer the slurry from the first stage pump 12 to the second stage pump 14 while minimizing the loss of the first pressure. In one embodiment, the fluid connection 16 may be less than about twenty feet (about six meters) in length but greater than about two inches (about five centimeters).

The second stage pump 14 may pressurize the slurry to the second pressure above the first pressure at the outlet. In one embodiment, the second pressure may be in a range from about 60 PSI to about 100 PSI. The second stage pump 14 may be a centrifugal pump, a vortex pump, or any other suitable pump capable of pressurizing the slurry from the first pressure and discharging it at the second pressure and at a sufficient flow rate for a fracturing operation. The second stage pump 14 may discharge the slurry, at the second pressure, to the manifold 25 or directly to a high pressure pump for distribution into the wellbore for fracturing the formation.

In one embodiment, the blending system 10 includes a support structure 26 supporting the first stage pump 12 and the second stage pump 14. The support structure 26 may be a trailer, a skid, or other suitable support structure capable of supporting the first and second stage pumps 12 and 14 during a fracturing operation. An exemplary support structure 26 implemented on a trailer is shown in FIG. 6, for example. In particular, the blending system 10 shown in FIG. 6 is integrated onto the support structure 26 and positioned below a support frame for supporting one or more modular silos (not shown) which are positioned to deliver oilfield material into a hopper 27 of the blending system 10.

Referring now to FIG. 2, therein shown is one embodiment of the first stage pump 12. The first stage pump 12 is provided with the hopper 27 that provides a container for the dry component 22, such as sand (not shown) or other types of proppant. In this embodiment the hopper 27 is mounted on the top side of a housing 28 and held in place by supports 30-1 and 30-2. As illustrated, a bottom end of the hopper 27 forms an outlet 32, which may terminate just above a first inlet 34 in the housing 28. Dry component 22 from the hopper 27 may be dropped or deposited into the housing 28 through the first inlet 34 by gravity, for example. Positioning the outlet 32 just above the first inlet 34 may provide an exterior air exhaust space 36 between the hopper 27 and the first inlet 34.

A drive shaft 38 is positioned inside the hopper 27, such that the bottom of the drive shaft 38 extends through the first inlet 34 and into the housing 28. The drive shaft 38 may be driven by a motor 40 at a top end of the shaft 38, for example. The motor 40 may be supported by rods 42-1 and 42-2 that may be fastened into the housing 28. The mixer 18 of the first stage pump 12 may include the housing 28, a slinger member 44 and an impeller member 46 provided within the housing 28. In one embodiment, the mixer 18 may be a vortex mixer. The impeller member 46 is secured to a bottom end of the drive shaft 38 by a bolt fastener 48 or other suitable connector. An underside surface 49 of the slinger member 44 may have a recess therein, so that when the impeller member 46 is fastened to the slinger member 44 an interior air exhaust space 50 is defined between the underside surface 49 of the slinger member 44 and a topside surface 51 of the impeller member 46.

The slinger member 44 has a central opening (not shown) therein that allows it to fit over the bottom end of the drive shaft 38 above the bolt fastener 48. The slinger member 44 may have a toroidal configuration, including a concave surface that faces toward a top of the housing 28. The slinger member 44 may also include some air exhaust channels 52, shown as air exhaust channels 52-1 and 52-2, that extend substantially diagonally through a body of the slinger member 44. One end of each air exhaust channel 52-1 and 52-2 communicates with the interior exhaust space 50, and an opposite end defines an opening along the concave surface of the slinger member 44. The impeller member 46 has a configuration to cause a vortex when the impeller member 46 is spun by the drive shaft 38, with a concave surface which faces toward a bottom of the housing 28.

In the embodiment illustrated in FIG. 2, the topside concave surface of the slinger member 44 is interrupted by several upstanding blade members 44-1 and 44-2. The housing 28 encloses the slinger member 44 and impeller member 46, and the housing 28 includes an outlet port 54, for discharging the slurry from the housing 28 at the first pressure. One end of a second inlet 56 may be connected into the housing 28 and an opposite end of the conduit is connected into a source for a liquid component, such as a gel. During a mixing operation, the liquid component may be drawn into the housing 28 through the second inlet 56 and a suction-eye inlet 58 at the bottom of the housing 28 at the initial pressure.

In operation, the first stage pump 12 may mix dry components with liquid components to form a slurry suitable for injecting into a wellbore to stimulate recovery of oil or gas from a formation accessed by the wellbore. The motor 40 may rotate the drive shaft 38, slinger member 44, and impeller member 46 at a suitable RPM to pressurize the slurry between 10-50 PSI as discussed above. A predetermined amount of dry component may be added to the hopper 27, so that the dry component flows in a continuous stream through the first inlet 34 and drops onto the rotating slinger member 44. As the dry component drops onto the slinger member 44, the vortex action of the impeller member 46 may create a suction force inside the housing 28 which pulls the liquid component into the housing 28 through the suction-eye inlet 58. As the liquid component is pulled into the housing 28, it may be pressurized to the first pressure by the impeller member 46 and interfaces with the dry component being flung outwardly by the slinger member 44, thereby forming the slurry. The slurry may be released from the outlet port 54 at the first pressure and passed through the fluid connection 16 (shown in FIG. 1) to the second stage pump 14.

The fluid connection 16 may be a hose, pipe, combination thereof, or any other suitable fluid connection capable of transmitting the slurry at the first pressure from the first stage pump 12 to the second stage pump 14. In one embodiment the fluid connection 16 may be less than 20 feet or less than about 6 meters. The first stage pump 12, the fluid connection 16, and the second stage pump 14 may be positioned so as to minimize the pressure loss between the first stage pump 12 and the inlet of the second stage pump 14. For example, first stage pump 12, the fluid connection 16, and the second stage pump 14 may be positioned so as to prevent a loss of pressure greater than 20% of the first pressure.

Referring now to FIGS. 3 and 4, shown therein is one embodiment of a second stage pump 14. The second stage pump 14 may be a centrifugal pump capable of receiving the slurry, pressurizing the slurry to a second pressure, and discharging the slurry at the second pressure. As shown in FIGS. 3 and 4, the second stage pump 14 may be a recessed cup impeller pump, which is one form of a centrifugal pump. In this embodiment, the second stage pump 14 is provided with a drive shaft 62, an impeller 64 driven by the drive shaft 62 about a central axis, a pump casing 66 surrounding the impeller 64 and defining a pressurization chamber 68, an inlet 70 in the pump casing 66 in fluid communication with the pressurization chamber 68, and an outlet 72 in the pump casing 66 in fluid communication with the pressurization chamber 68. A motor (not shown) may cause the drive shaft 62 to rotate, thereby rotating the impeller 64. The slurry, discharged from the first stage pump 12, enters the second stage pump 14 at the inlet 70 and flows into the pressurization chamber 68. The motion of the impeller 64 causes the slurry to be forced radially outward, thereby pressurizing the slurry to the second pressure so as to discharge the slurry through the outlet 72. A fluid connection between the second stage pump 14 and the manifold 25 may transmit the slurry from the outlet 72 at the second pressure from the second stage pump 14 to the manifold 25.

Referring now to FIG. 5, in use, the blending system 10 may be installed at an oilfield operation site, at block 100. Installing the blending system 10 may be performed by initially transporting the blending system 10 to the well site. The blending system 10 may be transported to the well site via semi-trailer as shown in FIG. 6, on a skid, or in any other suitable method. Installation may continue by positioning the hopper 27 of the first stage pump 12 to receive the dry component 22 from a silo or other source of the dry component 22 and connecting a source of the liquid component 20 to the second inlet 56 of the first stage pump 12. The first stage pump 12 may be operated such that the drive shaft 38 rotates at a predetermined speed, as indicated by block 102. For example, the drive shaft 38 may rotate in a range from about 900-1100 RPM, depending on a predetermined discharge pressure of the first stage pump 12. The outlet 72 of the second stage pump 14 is connected to the manifold 25 or high pressure pump. The dry component 22 may be transferred into the hopper 27, at block 104, by transferring dry component 22 into the hopper 27 by a gravity feeder, by an automated conveyor, or other suitable methods. The liquid component 20 may be transferred into the second inlet 56, as indicated by block 106, at an initial pressure.

While transferring the dry component 22 and the liquid component 20 into the first stage pump 12, the mixer 18 of the first stage pump 12, receiving the liquid component 20 at the initial pressure and the dry component 22, may be operated to mix the dry component 22 and the liquid component 20 into a slurry 108, as indicated by block 110. The mixer 18 may add energy to the slurry 108 to increase a pressure of the slurry 108 to be above the initial pressure at the outlet 23. The slurry 108, mixed in the mixer 18 of the first stage pump 12, may be pressurized to a first pressure 112 which is above hydrostatic pressure and above the initial pressure, at block 114. In one embodiment, the first pressure 112 may be in a range from about 10 PSI to about 50 PSI. The slurry 108 may then be discharged through the fluid connection 16 at block 116 to the second stage pump 14. At block 118, the second stage pump 14 may be operated to pressurize the slurry 106 to a second pressure 120 in a range from about 50 PSI to about 100 PSI. The slurry 106 may be discharged from the second stage pump 14, for example to the manifold 25, via a fluid connection, at block 122.

The preceding description has been presented with reference to some embodiments. Persons skilled in the art and technology to which this disclosure pertains will appreciate that alterations and changes in the described structures and methods of operation can be practiced without meaningfully departing from the principle, and scope of this application. Accordingly, the foregoing description should be read as consistent with and as support for the following claims, which are to have their fullest and fairest scope.

The scope of patented subject matter is defined by the allowed claims. Moreover, the claim language is not intended to invoke paragraph six of 35 USC §112 unless the exact words “means for” are used. The claims as filed are intended to be as comprehensive as possible, and no subject matter is intentionally relinquished, dedicated, or abandoned.

What is claimed is:

1. A blending system for oilfield operations, comprising:
a first stage pump having a mixer having a housing and an impeller and configured to receive a liquid component at an initial pressure and a dry component, mix the liquid component and the dry component to form a slurry, add energy to the slurry to increase a pressure of the slurry above the initial pressure at an outlet, and discharge the slurry through the outlet at a first pressure above hydrostatic pressure and above the initial pressure of the liquid component; and
a second stage pump having an inlet and an outlet, the inlet in fluid communication with the first stage pump, the second stage pump configured to receive the slurry from the first stage pump and pressurize the slurry to a second pressure above the first pressure at the outlet, wherein the second stage pump is positioned relative to the first stage pump to minimize a pressure loss between the first stage pump and the inlet of the second stage pump.

2. The blending system of claim 1 further comprising a support structure supporting the first stage pump and the second stage pump.

3. The blending system of claim 2, wherein the support structure is a trailer.

4. The blending system of claim 2, wherein the support structure is a skid.

5. The blending system of claim 1, wherein the first pressure is in a range from 10 PSI to 50 PSI.

6. The blending system of claim 1, wherein the second pressure is in a range from 50 PSI to 100 PSI.

7. The blending system of claim 1, wherein the mixer is a vortex mixer.

8. The blending system of claim 1, wherein the second stage pump is a centrifugal pump.

9. The blending system of claim 1, wherein the second stage pump is a vortex pump.

10. The blending system of claim 1, wherein the fluid communication between the first stage pump and the second stage pump is formed by a connection mechanism measuring less than 20 feet but greater than two inches.

11. The blending system of claim 10, wherein the connection mechanism is a hose.

12. The blending system of claim 10, wherein the connection mechanism is a pipe.

13. The blending system of claim 1, wherein the pressure loss between the first stage pump and the inlet of the second stage pump is minimized to prevent a loss of pressure greater than 20% of the first pressure.

14. A blending system, comprising:
a blender comprising:
a hopper for containing a dry component of an oilfield material slurry, the hopper having an inlet and an outlet,
a first stage pump having a first inlet and a second inlet, the first inlet in fluid communication with the outlet of the hopper to receive the dry component of the oilfield material slurry, and the second inlet configured to receive a liquid component of the oilfield material slurry, the first stage pump having a mixer with a housing and an impeller and configured to receive the liquid component at an initial pressure and the dry component, mix the liquid component and the dry component to form the oilfield material slurry, add energy to the oilfield material slurry to increase a pressure of the oilfield material slurry above the initial pressure at an outlet, and discharge the oilfield material slurry through the outlet at a first pressure above hydrostatic pressure and above the initial pressure of the liquid component;
a second stage pump in fluid communication with the first stage pump, the second stage pump configured to receive the oilfield material slurry from the first stage pump and pressurize the oilfield material slurry to a second pressure for discharge, wherein the second stage pump is positioned relative to the first stage pump to minimize a pressure loss between the first stage pump and the inlet of the second stage pump.

15. The blending system of claim 14, further comprising a support structure configured to support the blender and the second stage pump.

16. The blending system of claim 14, wherein the first pressure is in a range from 10 PSI to 50 PSI.

17. The blending system of claim 14 wherein the second pressure is in a range from 50 PSI to 100 PSI.

18. The blending system of claim 14, wherein the fluid communication between the blender and the second stage pump is formed by a connection mechanism measuring less than 20 feet but greater than two inches.

19. A method, comprising:
installing a blending system at a well site operation, the blending system comprising a first stage pump and a second stage pump, the second stage pump being positioned relative to the first stage pump to minimize a pressure loss between the first stage pump and the second stage pump;
transferring a dry component and a liquid component into the first stage pump;
operating the first stage pump to mix the dry component and the liquid component to form a slurry, pressurize and discharge the slurry from the first stage pump at a first pressure above hydrostatic pressure; and
operating the second stage pump to pressurize and discharge the slurry from the second stage pump at a second pressure above the first pressure.

20. The method of claim 19, wherein the blending system is installed at a well site location for a hydraulic fracturing operation.
